(19) United States
(12) Patent Application Publication
(10) Pub. No.: US 2007/0076096 A1
(43) Pub. Date: Apr. 5, 2007

(54) System and method for calibrating a set of imaging devices and calculating 3D coordinates of detected features in a laboratory coordinate system

(76) Inventor: Eugene J. Alexander, San Clemente, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/543,386

(22) Filed: Oct. 4, 2006

Related U.S. Application Data
(60) Provisional application No. 60/723,864, filed on Oct. 4, 2005.

(51) Int. Cl. H04N 5/225; H04N 17/00; H04N 17/02

(52) U.S. Cl. 348/169; 348/180

(57) ABSTRACT

A system and method are presented for calibrating a set of imaging devices for generating three dimensional surface models of moving objects and calculating three dimensional coordinates of detected features in a laboratory coordinate system, when the devices and objects are moving in the laboratory coordinate system. The approximate location and orientation of the devices are determined by one of a number of methods: a fixed camera system, or an attitude sensor coupled with an accelerometer, a differential GPS approach, or a timing based system. The approximate location and orientation of the device is then refined using to a very highly accurate determination using an iterative approach and de-focusing calibration information.

### BACKGROUND OF THE INVENTION

1. Field of the Invention

The invention relates generally to apparatus and methods for calibrating an imaging device for generating three-dimensional surface models of moving objects and calculating three-dimensional coordinates of detected features relative to a laboratory coordinate system.

2. Background of the Invention

The generation of three dimensional models of moving objects has uses in a wide variety of areas, including motion pictures, computer graphics, video game production, human movement analysis, orthotics, prosthetics, surgical planning, sports medicine, sports performance, product design, surgical planning, surgical evaluation, military training, and ergonomic research.

Two existing technologies are currently used to generate these moving 3D models. Motion capture techniques are used to determine the motion of the object, using retro-reflective markers such as those produced by Motion Analysis Corporation, Vicon Ltd., active markers such as those produced by Chamwood Dynamics, magnetic field detectors such as those produced by Ascension Technologies, direct measurement such as that provided by MetaMotion, or the tracking of individual features such as that performed by Peak Performance, SIMI. While these various technologies are able to capture motion, nevertheless these technologies do not produce a full surface model of the moving object, rather, they track a number of distinct features that represent a few points on the surface of the object.

To supplement the data generated by these motion capture technologies, a 3D surface model of the static object can be generated. For these static objects, a number of technologies can be used for the generation of full surface models: laser scanning such as that accomplished by CyberScan, light scanning such as that provided by Inspeck, direct measurement such as that accomplished by Direct Dimensions, and structured light such as that provided by Eyetronics or Vitronic.

While it may be possible to use existing technologies in combination, only a static model of the surface of the object is captured. A motion capture system must then be used to determine the dynamic motion of a few features on the object. The motion of the few feature points can be used to extrapolate the motion of the entire object. In graphic applications, such as motion pictures or video game production applications, it is possible to mathematically transform the static surface model of the object from a body centered coordinate system to a global or world coordinate system using the data acquired from the motion capture system.

As one element of a system that can produce a model of the surface a three dimensional object, with the object possibly in motion and the object possibly deforming in a non-rigid manner, there exists a need for a system and method for calibrating a set of imaging devices and calculating three dimensional coordinates of the surface of the object in a laboratory coordinate system. As the imaging devices may be in motion in the laboratory coordinate system, an internal camera parameterization is not sufficient to ascertain the location of the object in the laboratory coordinate system. However, if the location and orientation of the imaging devices can be established in the laboratory coordinate system and the location of the object surfaces can be ascertained relative to the imaging devices (from an internal calibration), it is possible to determine the location of the surface of the object in the laboratory system. In order to achieve this goal, a novel system and method for determining the location of a surface of an object in the laboratory system is developed.

### BRIEF DESCRIPTION OF THE DRAWINGS

The drawings illustrate the design and utility of preferred embodiments of the invention, in which similar elements are referred to by common reference numerals and in which:

FIG. 1 is a side view of a subject moving in a laboratory while multiple imaging devices are trained on the subject device for calibrating an imaging device

FIG. 2 shows a subject moving in a laboratory while multiple manually controlled imaging devices move with the subject.

FIG. 3 shows a subject moving in a laboratory while multiple imaging devices, mounted on robotic platforms move with the subject

FIG. 4 illustrates one approach for determining the location of the imaging device through the use of a set of fixed cameras.

FIG. 5 depicts a set of imaging devices configured to operate with an attitude sensor and three different location sensors.

FIG. 6 depicts imaging devices configured to operate with a differential global positioning system, an accelerometer, or both.

FIG. 7 illustrates imaging devices configured to work with a timing system to create a global positioning system within a laboratory.

FIG. 8 shows the use of a calibration object to calibrate an imaging device

FIG. 9 shows an actual data acquisition session.

FIG. 10 shows the data acquisition session of FIG. 9 as the subject walks through the laboratory.

FIG. 11 depicts a four-dimensional surface created from the projection of surface points from the three dimensional surface of the subject of FIG. 10

FIG. 12 depicts the mathematically corrected four dimensional surface of FIG. 11 and the optimal placement of the imaging devices.

### DETAILED DESCRIPTION

Various embodiments of the invention are described hereinafter with reference to the figures. It should be noted that the figures are not drawn to scale and elements of similar structures or functions are represented by like reference numerals throughout the figures. It should also be noted that the figures are only intended to facilitate the description of specific embodiments of the invention. They are not intended as an exhaustive description of the invention or as a limitation on the scope of the invention. In addition, an aspect described in conjunction with a particular embodiment of the invention is not necessarily limited to that embodiment and can be practiced in any other embodiment of the invention.

Previous internal calibration procedures provide all the internal camera and projector parameters needed to perform a data acquisition. Devices which combine cameras and a projector into one device are referred to as an imaging device. The imaging device is a device that is capable of producing a three dimensional representation of the surface of one aspect of a three dimensional object such as the device described in U.S. Patent Application Serial Number pending, entitled Device for Generating Three Dimensional Surface Models of Moving Objects, filed concurrently with the present patent application on Oct. 4, 2006, which is incorporated by reference into the specification of the present patent in its entirety.

Such an imaging device has a mounting panel. Contained within the mounting panel of the imaging device are grey scale digital video cameras. There may be as few as two grey scale digital video cameras and as many grey scale digital video cameras as can be mounted on the mounting panel. The more digital video cameras that are incorporated, the more detailed the model generated is. The grey scale digital video cameras may be time synchronized. The grey scale digital video cameras are used in pairs to generate a 3D surface mesh of the subject The mounting panel may also contain a color digital video camera. The color digital video camera may be used to supplement the 3D surface mesh generated by the grey scale camera pair with color information.

Each of the video cameras have lenses with electronic zoom, aperture and focus control. Also contained within the mounting panel is a projection system. The projection system has a lens with zoom and focus control. The projection system allows an image, generated by the imaging device, to be cast on the object of interest, such as an actor or an inanimate object.

Control signals are transmitted to the imaging device through a communications channel. Data is downloaded from the imaging device through another communications channel. Power is distributed to the imaging device through a power system. The imaging device may be controlled by a computer.

However, most often the imaging device performing this data acquisition will be moving, either by rotating about a three degree of freedom orientation motor and/or the overall system may also be moving arbitrarily through the volume of interest. The imaging devices move in order to maintain the test subject in an optimal viewing position.

In operation, as an object or person moves through the volume of interest, the imaging devices rotate, translate, zoom and focus in order to keep a transmitted pattern in focus on the subject at all times. This transmitted pattern could be a grid—or possibly some other pattern—and is observed by multiple cameras on any one of the imaging devices. These imaging devices correspond the pattern (as seen by the multiple cameras on the imaging unit), to produce a single three-dimensional mesh of one aspect of the subject. As multiple imaging devices observe the subject at one time, multiple three-dimensional surface meshes are generated and these three-dimensional surface meshes are combined in order to produce a single individual three-dimensional surface mesh of the subject as the subject moves through the field of view.

The determination of the location and orientation of the mesh relative to the individual imaging unit can be determined through an internal calibration procedure. An internal calibration procedure is a method of determining the optical parameters of the imaging device, relative to a coordinate system embedded in the device. Such a procedure is described in U.S. Patent Application Serial Number pending, entitled Device and Method for Calibrating an Imaging Device for Generating Three Dimensional Surface Models of Moving Objects, provisional application filed on Nov. 10, 2005, which is incorporated by reference into the specification of the present patent in its entirety. However, in order to be able to combine the individual surface meshes, it is necessary to know the location and orientation of the individual surface meshes relative to some common global coordinate system to a high degree of accuracy. As shown in one embodiment of the invention, an approach to determining the location and orientation of these meshes is to know the location and orientation of the meshes relative to the imaging unit that generated them and to then know the location and orientation of that imaging unit relative to the global coordinate system.

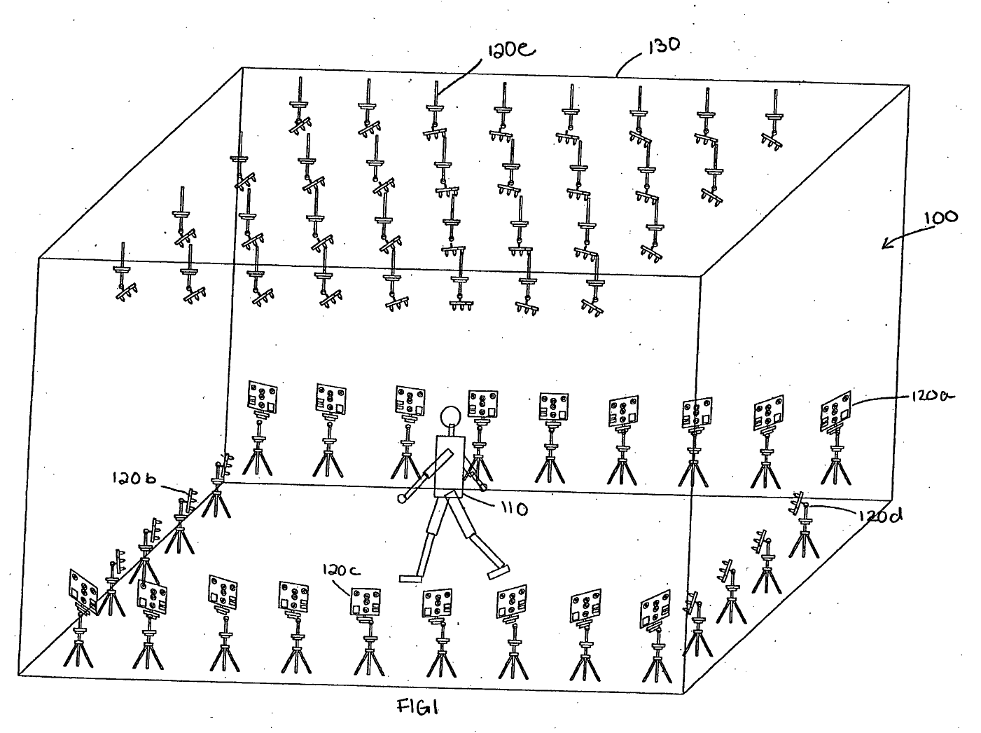

Turning now to the drawings, FIG. 1 shows a subject 110 walking through a laboratory 100. In one embodiment, as the subject 110 moves from one location in the laboratory 100 to another, all of the individual imaging devices 120 have their roll, yaw and pitch controlled by a computer (not shown) such as a laptop, desktop or workstation, in order to stay focused on the subject 110 as the subject 110 walks through the laboratory 100. For illustration, only individual imaging devices 120(a-e) have been identified in FIG. 1. However, as shown in FIG. 1, there may be a multitude of imaging devices, one of skill in the art will appreciate that the number of imaging devices depicted is not intended to be a limitation. Moreover, the number of imaging devices may vary with the particular imaging need. In order to ensure that the projected pattern is visible on the subject 110, as the subject 110 moves close to an imaging device 120, that specific imaging device 120 is the one that is used to generate the 3-D surface model. As the subject 110 walks through the laboratory 100, all of the imaging devices (i.e. 120(e)) on the ceiling 130 rotate their yaw, pitch and roll in order to stay focused on the subject 110.

FIG. 1 represents one approach to using these multiple imaging devices 120(a-e) at one time to image a subject 110 as the subject 110 moves through a laboratory 100. However, this technique requires many imaging devices 120 to cover the entire volume of interest. Other approaches as illustrated herein are also possible, which do not require as many imaging devices 120.

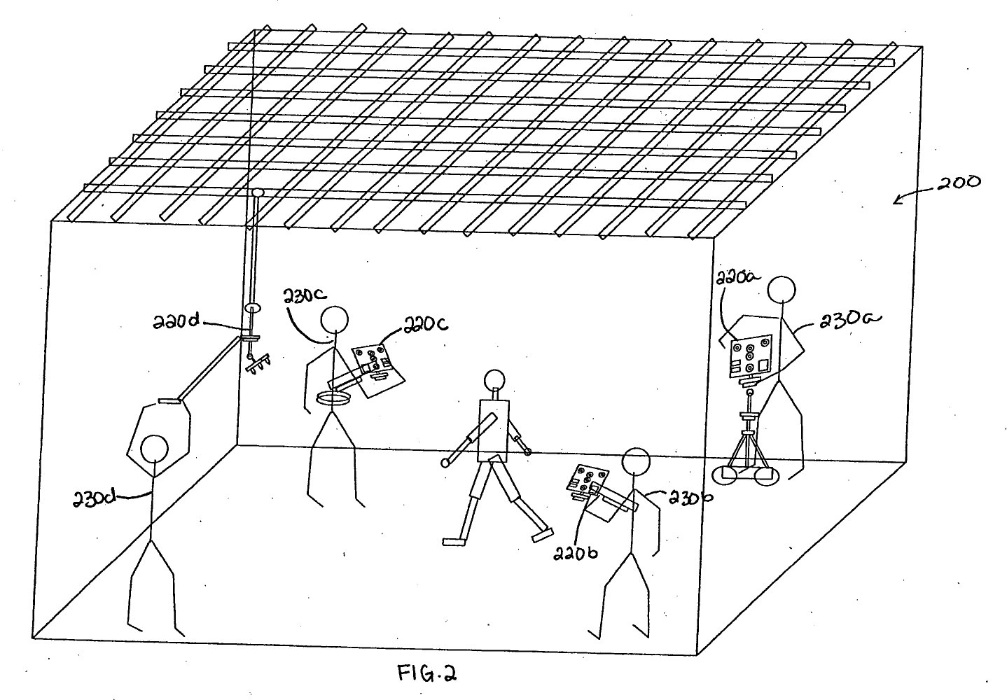

FIG. 2 shows another embodiment of the invention where fewer imaging devices are utilized, for example 6 or 8 or 10 or 12. In this embodiment, the imaging devices (i.e., 220(a-d) move with a subject 210 as the subject 210 moves through the laboratory 200. As the subject 210 moves throughout the volume of interest, the camera operators (i.e., 230(a-d)), who are manually controlling the imaging devices 220(a-d), move with the subject 210 and keep the subject 210 in the field of view of the imaging device 220(a-d) during the entire range of the activity. The camera operator 220(a-d) may control the imaging device through any of a number of modalities: for example, a shoulder mount, a motion-damping belt pack, a movable ground tripod or a movable overhead controlled device could be used for holding the camera as the subject walks through the volume of interest. While FIG. 2, depicts four imaging devices and four operators, this is not intended to be a limitation as explained previously, there may be a multitude of imaging devices, and operators. Moreover, the number of imaging devices may vary with the particular imaging need.

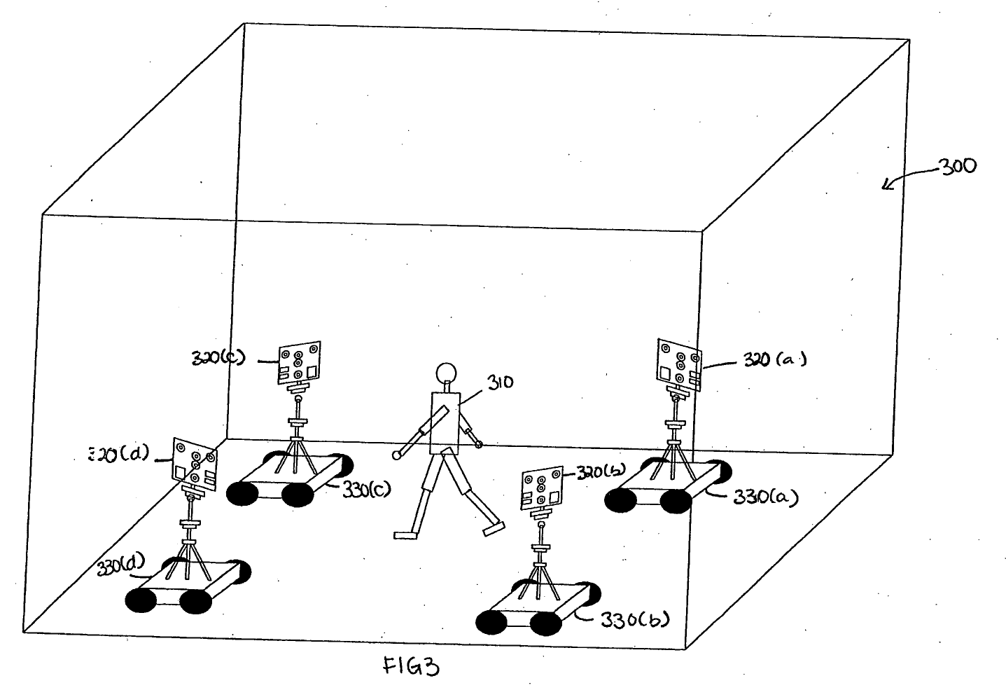

FIG. 3 depicts yet another embodiment of the invention. In this embodiment, the imaging devices 320(a-d) are attached to mobile camera platforms 330(a-d) that may be controlled through a wireless network connection. The imaging devices (i.e., 320(a-d) move with a subject 310 as the subject 310 moves through the laboratory 300. As shown, the imaging device 320(a-d) is mounted on a small mobile robotics platform 330(a-d). Mobile robotic platforms are commonly commercially available, such as those manufactured by Engineering Services, Inc., Wany Robotics, and Smart Robots, Inc. While robotic platforms are commonly available, the platform must be modified for use in this embodiment of the invention. A robotic standard platform is modified by adding a telescoping rod (not shown) on which the camera imaging device 320 is mounted. The controller of the individual camera has a small, joystick-type device attached to a computer, for controlling the mobile camera platform through a wireless connector. While FIG. 3 illustrates four imaging devices on platforms, this is not intended to be a limitation on the number of imaging devices. Moreover, the number of imaging devices may vary with the particular imaging need.

In order to properly use the mobile imaging devices it is necessary to determine the location and orientation of the robotic platform, and subsequently the imaging device, in the laboratory (global) coordinate system. There are a number of different approaches for determining the location of the imaging devices within the volume.

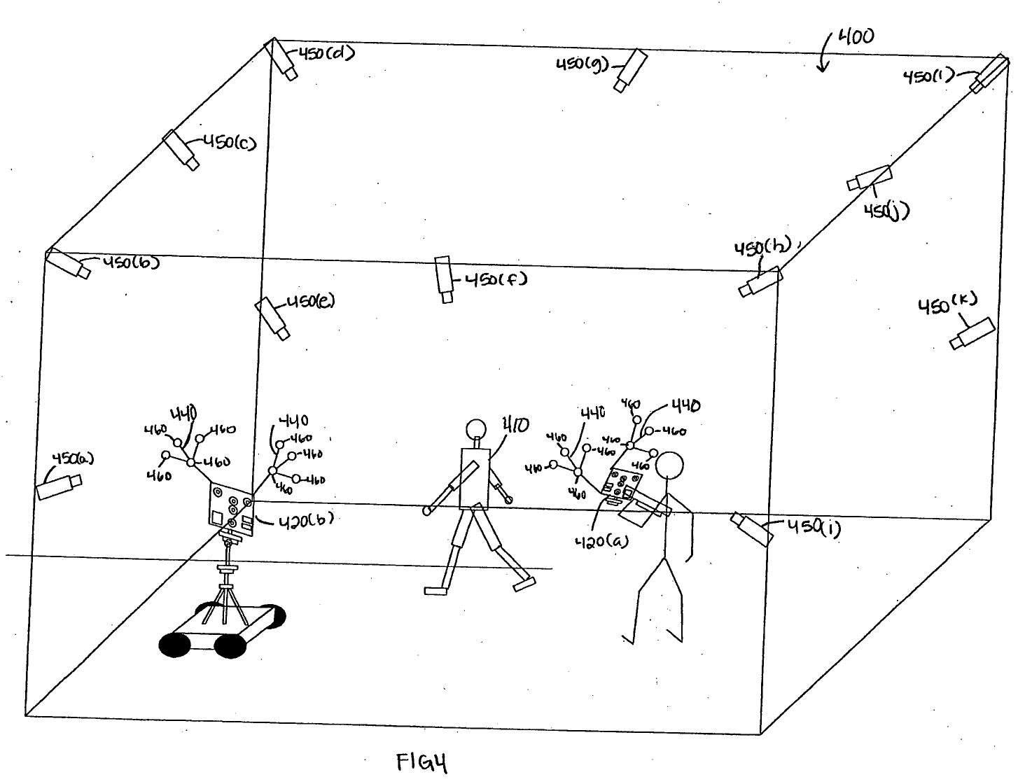

FIG. 4 illustrates one approach for determining the location of the imaging device through the use of a set of fixed cameras to determine the changing location and orientation of the imaging units. FIG. 4 shows a subject 410 moving through a laboratory 400, a number of fixed cameras 450(a-l) are placed in the extremities of the laboratory 400. A set of orthogonal devices 440, that are easily viewed by the fixed cameras 450(a-l), are attached to the mobile imaging units 420(a-b). In one example of an easily observed device, a number of retro-effective markers 460 are mounted at the center and along the axes of an orthogonal coordinate system 440. The location of the clusters of retro-effective markers 460 rigidly attached to the imaging device 420(a-b) is determined. As the cluster of markers 460 is rigidly fixed to the imaging device, a rigid body transformation can be calculated to determine the location and orientation of the rigid coordinate system embedded in the imaging device 420(a-b).

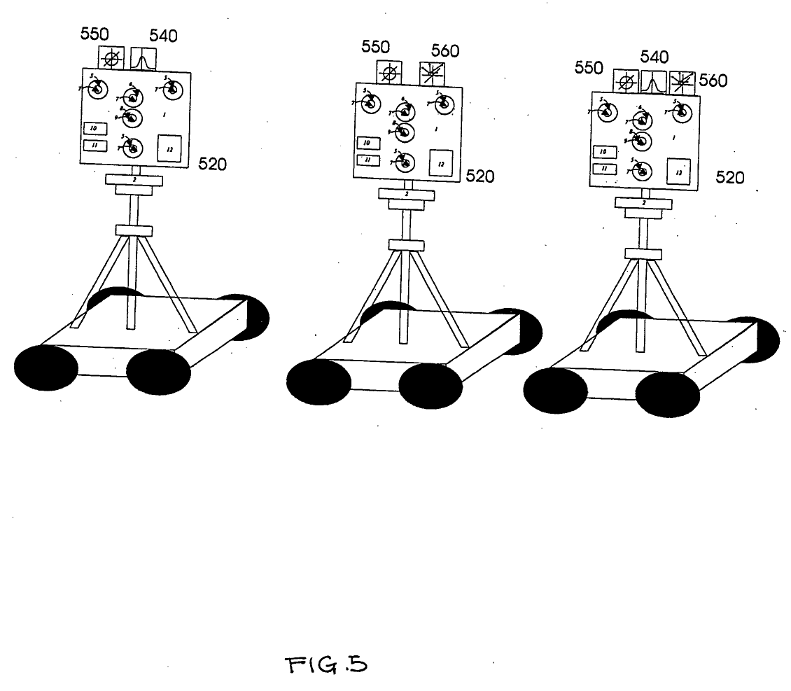

In another embodiment of the invention, instead of using the retro-effective cluster of markers to determine the location and orientation of the imaging devices in the volume, a three degree-of-freedom (DOF) attitude sensor is used to determine the orientation of the imaging device, and any of a number of different approaches can be used to determine the location of the imaging device, a number of which are described below. FIG. 5 shows three imaging devices 520 configured to operate with a three DOF orientation sensor 550 and either an accelerometer 540, a GPS receiver 560, or an accelerometer 540 and a GPS receiver 560 (a redundant configuration). The orientation sensors provide the orientation of the device through the entire volume of a laboratory as a camera operator moves the imaging device to follow the subject (not shown). The movement of the imaging device may be manual as depicted in FIG. 3 or through remote means as depicted in FIG. 4. An accelerometry-based approach is prone to a drift error, and a GPS receiver could then be used to correct for this drift error.

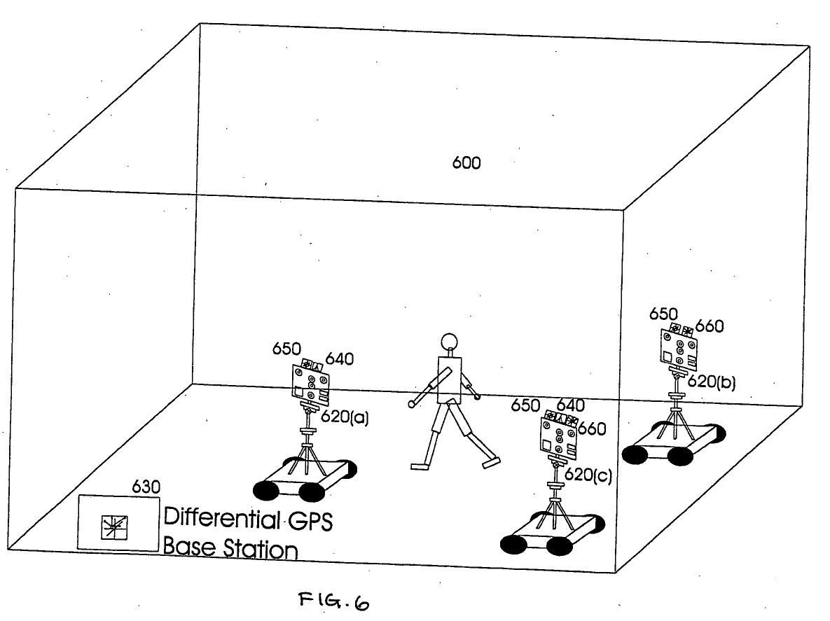

In still another embodiment of the invention, a differential GPS approach in the laboratory 600 provides a fixed reference coordinate system for the GPS receivers 660 on each of the individual imaging devices 620 as shown in FIG. 6. This differential GPS base station 630 is used to correct for the induced and accidental errors associated with standard GPS. Using differential GPS with a known base station location, it's possible to reduce the GPS error correcting the accelerometry data from the device down to the 1-centimeter range.

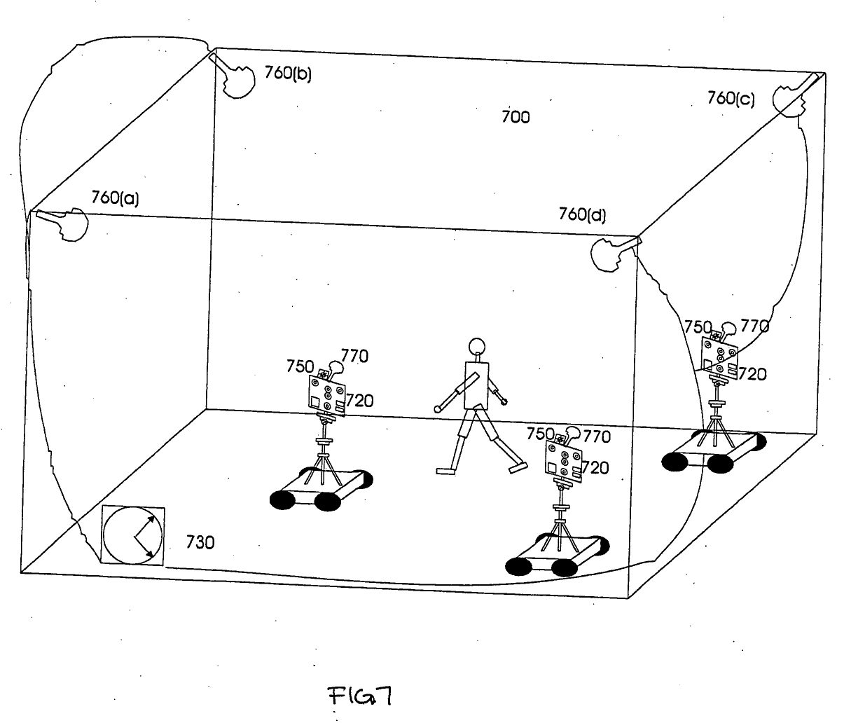

In another embodiment, a timing system is used to essentially establish a unique GPS within a laboratory 700. As shown in FIG. 7, a master clock 730 is distributed to transmitters 760(a-d) that are located about the perimeter of the laboratory 700. In this embodiment there is a distribution of a timing signal to each of these transmitters 760(a-d).

Using the clock 730 distributed by these transmitters, a radio signal would be sent into the laboratory 700 and received by each of the individual camera projector units 770. The camera projector units 770 would respond to this radio signal by sending a time-stamp tag back to the transmitters. Each of the individual transmitters 760(a-d) would then have time of flight information—from the transmitter 760(a-d) to the individual mobile camera unit 770 and back to the transmitter 760(a-d). This information, from an individual transmitter-receiver, provides extremely accurate distance measurement from that transmitter to that mobile imaging unit 720. Using multiple results, a number of spheres are intersected to provide an estimate of the location of the individual imaging device 720.

In operation, these same types of receiver-transmitter pairs will be placed on each of the individual imaging projector devices to provide the location of each of the devices around the laboratory to a high degree of accuracy. The orientation of the devices will still need to be determined using a three-degree-of-freedom orientation sensor 750.

Any of the techniques described above produce an initial estimate of the location and orientation of each of the imaging devices. However, this initial estimate may not be accurate enough for all applications. In order to improve the accuracy an additional calibration procedure may be performed.

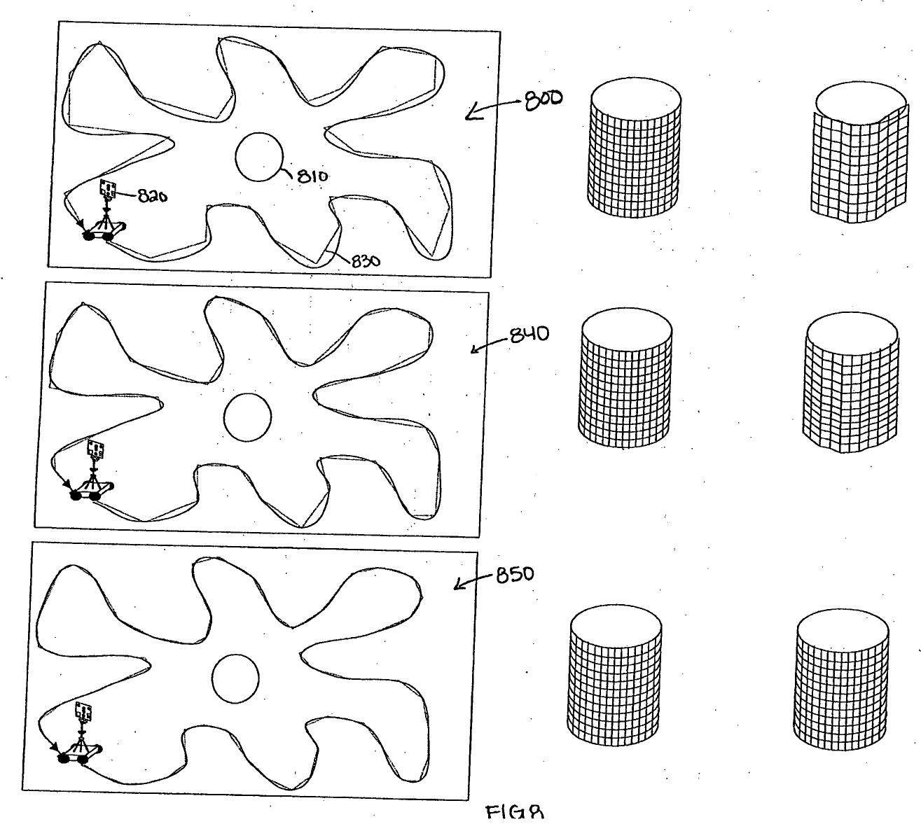

FIG. 8 illustrates one embodiment of a calibration procedure. In order to calibrate the imaging device 820, a static calibration object 810 is placed in the in the center of the laboratory coordinate system 800 of the volume of interest. This static calibration object 810 may be for example, a cylinder with a white non-reflective surface oriented with its main axes perpendicular to the ground so that as an imaging device 820 moves around the calibration device, as depicted by the dotted line 830, a clean planar image is projected onto the cylindrical surface.

Using this information, each of the individual imaging devices 820 are brought into the volume of interest and moved through the volume of interest 800 and oriented toward the calibration object 810, in order to keep the calibration object in view. The information describing the calibration object 810, such as its size, the degree of curvature, and its reflectivity, is all known prior to the data acquisition. Over time, as each of the individual imaging devices observes the calibration device 810, a four-dimensional surface of the calibration object 810 over time is acquired. As this calibration object 810 is static, the motion is due entirely to the motion of the imaging device 820 within the volume of interest 800.

Since the exact geometry of the calibration object 810 is known and the expected defocusing information based on its non-planarity is also known, it can be assumed that the three-dimensional surface generated by the imaging device is true and that any error associated in the build-up of the model of the calibration device 810 is due to inaccuracies in the location and orientation estimate of the overall imaging device 820.

A technique for correcting the imaging device location and orientation is calculated, using the calibration data previously recorded (i.e. the various four-dimensional surface 800, 840, 850). This correction procedure is as follows: the four-dimensional surface that is the calibration device is sampled; then the estimate of the four-dimensional surface is calculated; this four-dimensional surface is fit with some continuous mathematical representation: for example using a spline, or a NURBS. Since the geometry of the calibration device is known, a geometric primitive, i.e., a cylinder, is used. The assumption being that the information is absolutely correct. Then, the assumption is that that the point-cloud, built up over time, is a non-uniform sampling of that four-dimensional surface. Defocus correction information is used to back-project the correction to the actual camera locations and re-sample the four-dimensional surface. Continuous looping in this pattern is performed until it converges to an optimal estimate of the four-dimensional surface location and, by implication, an optimal estimate of the location and orientation of the cameras' sampling of this surface.

With this information the four-dimensional surface that is a three-dimensional object moving through time when sampled, non-uniformly, by one of these three-dimensional imaging devices can be calculated.

This model-free approach to estimating the four-dimensional surface is the first estimate in determining how the three-dimensional object moves through the volume over time. From calibration techniques, the camera's internal parameters are known, the defocusing characteristics of the camera are known, a rough estimate of the location and orientation of the overall imaging device is known, and thus a correction factor for the imaging device as it moves within the volume is determined.

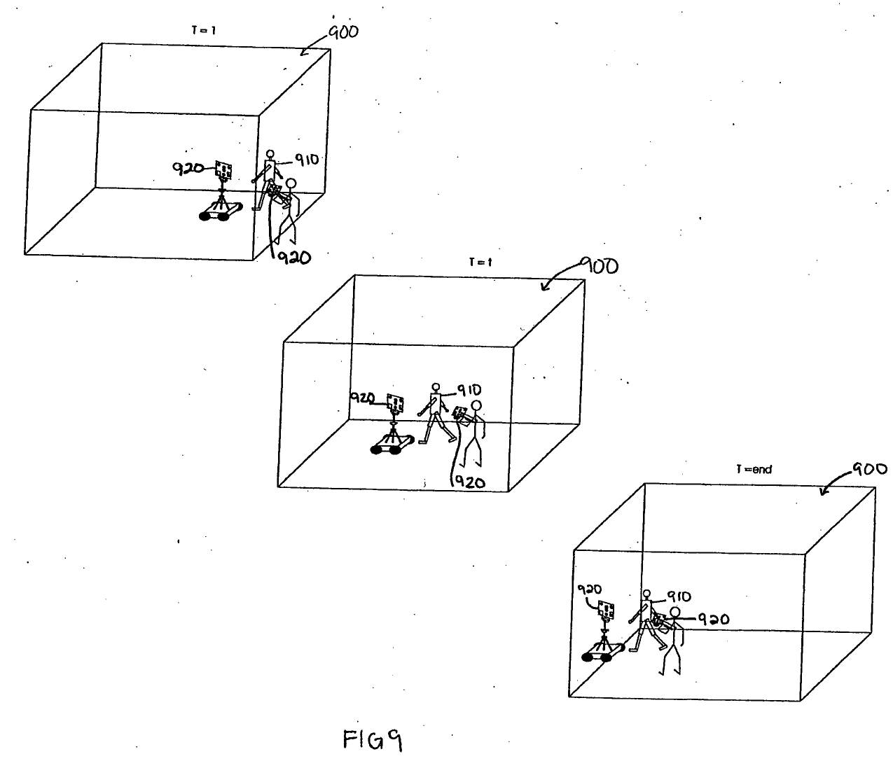

FIG. 9 shows an actual data acquisition session. Multiple imaging devices 920 are in operation as an object (in this instance a subject 910) moves through the volume of interest 900 over time (T=1-end). A sampling occurs of the four-dimensional surface. It is assumed that any error associated with one step of the acquisition is due to errors in the location and orientation of the imaging devices. In the second step of the iteration, the error is assumed to occur in the focusing of the imaging device on a non-planar object.

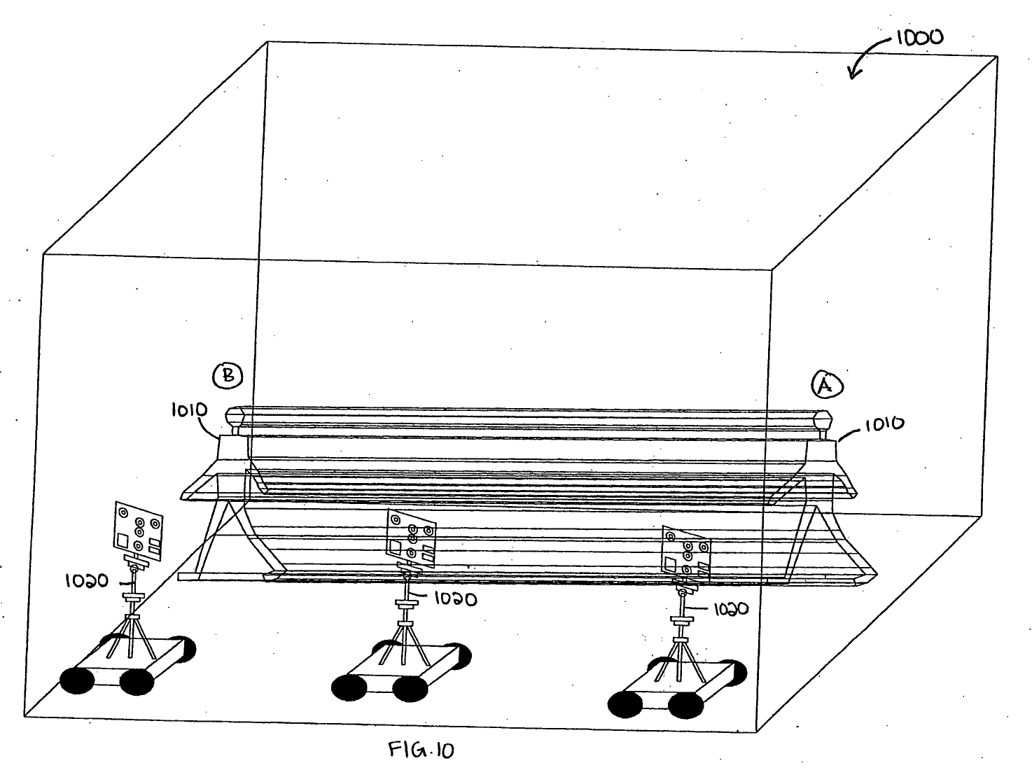

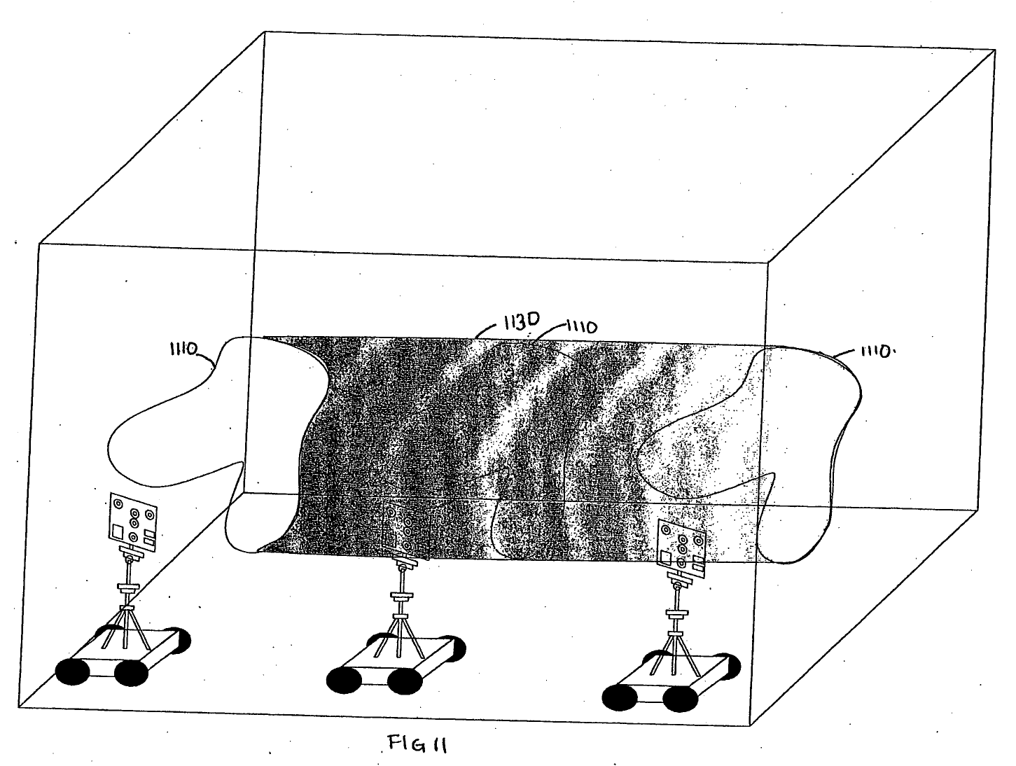

FIG. 10 shows the data acquisition session as the subject walks through the laboratory 1000 from position A to position B. The multiple imaging devices 1020 acquire data on various aspects of the three-dimensional surface of the subject 1010. The internal camera parameters are used to calculate the location of the subject 1010 relative to the individual imaging device coordinate systems. The known location and orientation of the imaging device coordinate systems are used to project the location of these surface points onto some four-dimensional surface 1130 as depicted in FIG. 11 in the laboratory coordinate system. The set of points in the four-dimensional laboratory coordinate system are assumed to be a non-uniform sampling of the actual object's (subject's 1110) motion over time. A mathematical representation is made of this surface, whether that representation be splines, NURBS, primitives, polyballs or any of a number of mathematically closed representations.

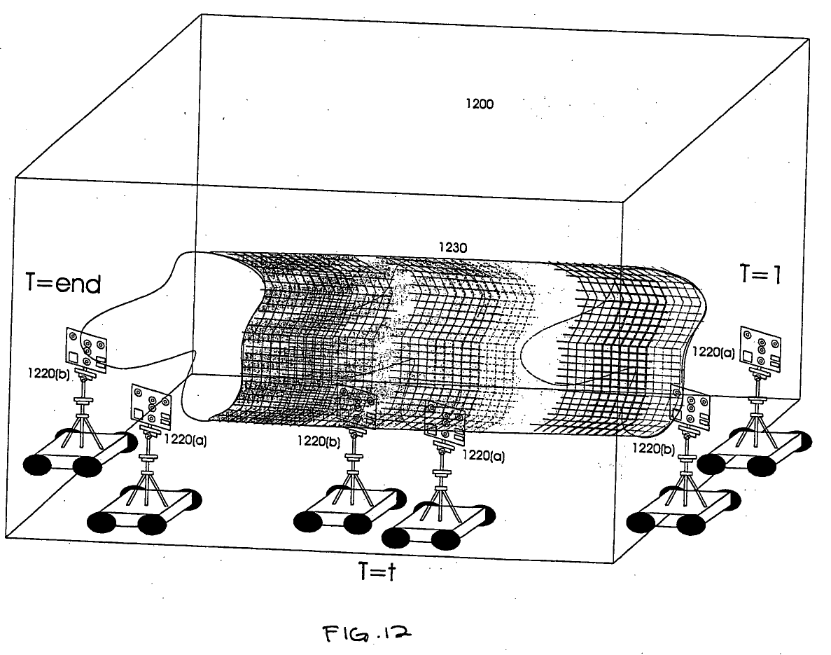

This surface 1230, as shown in FIG. 12, is estimated from the non-uniform sampling produced by the moving imaging devices 1220(a) and 1220(b), shown at 3 different times, T=1, T=t, and T=end. Each of the imaging devices 1220 initially generate a 3 dimensional mesh of one aspect of the surface of the subject (not shown). One of the previously described orientation and locations sensing techniques is used to determine the approximate location of the imaging devices. The 3D surface meshes from each of the imaging devices at all of the time intervals are transformed into the laboratory coordinate system 1200. A 4D surface is fit through this non-uniform sampling. Using the defocusing corrections and the previously determined camera location & orientation error correction functions, a back-projection is made to a new estimate of the camera location and orientation. The surface is re-sampled mathematically. This procedure is then iterated until convergence to an optimal estimate of the four-dimensional surface and location and orientation of the cameras. Actual calculation of this optimal estimation can be cast in a number of various forms. A preferred embodiment might be a Bayesian analysis where all the information on this subject is brought together over the entire time period to insure that no ambiguities exist. This can be done using the expectation maximization algorithm or a more standard linearly squares technique or a technique that is designed to maximize the probability that the data is a sampling of an actual underlying four-dimensional mathematical object.

The embodiments described herein have been presented for purposes of illustration and are not intended to be exhaustive or limiting. Many variations and modifications are possible in light of the forgoing teaching. The system is limited only by the following claims.

What is claimed:

1. A method for generating a surface model comprising:
utilizing multiple imaging devices;
locating the multiple imaging devices in a volume of interest;
controlling the imaging devices such that the imaging devices move with an object contained in the volume of interest;
determining the location and orientation of the imaging devices in the volume of interest; calibrating the imaging devices;
acquiring data about the object;
correcting the data; and
generating a three-dimensional model.

2. The method of claim 1, wherein the imaging devices are manually controlled.

3. The method of claim 1, wherein the imaging devices are remotely controlled.

4. The method of claim 3, wherein the imaging device is mounted on a mobile robotic platform.

5. A system for determining the location of an imaging device comprising:
at least two fixed cameras; and
at least two mobile imaging units wherein each mobile imaging unit comprises an orthogonal device.

6. The system of claim 5, wherein the orthogonal device comprises retro-reflective markers.

7. A system for determining the location of an imaging device comprising:
at least two mobile imaging units wherein each of the mobile imaging units comprises a three degree of freedom orientation sensor; and
a means for determining the location of the imaging units.

8. The method of claim 7, wherein the means for determining the location of the imaging units is an accelerometer.

9. The method of claim 7, wherein each of the mobile imaging units also comprises a Global Positioning System (GPS) receiver.

10. The method of claim 7, wherein the means for determining the location of the imaging unit is a master clock distributed to multiple transmitters about the perimeter of the room; and each of the mobile imaging units contain a system for receiving the master clock signal.

11. The method of claim 9, wherein the means for determining the location of the imaging unit is a differential GPS base station and each of the imaging units' GPS receivers is operated in differential mode.

12. A method for calibrating an imaging device in a volume of interest comprising:
locating the imaging devices in the volume of interest locating a calibration object in the approximate center of the volume of interest;
orienting the imaging device toward the calibration object;
moving the imaging device through the volume of interest acquiring data about the calibration object; and
generating a four dimensional surface of the calibration object.

13. The method of claim 11, wherein correcting the data further comprises:
sampling the four dimensional surface of the calibration object;
estimating the four-dimensional surface fitting the four dimensional surface to a known mathematical description of the calibration object;
extracting the error information between the calculated four dimensional surface of the calibration object and the precisely known mathematical description of the calibration object;
correcting the determination of the location and orientation of the imaging device over time using the error information; and
iterating this procedure until some exit criteria is reached

14. The method of claim 11, wherein multiple imaging devices are located in the volume of interest.

15. A system for generating a surface model comprising:
multiple imaging devices;
a means for locating the multiple imaging devices in a volume of interest;
a means for controlling the imaging devices such that the imaging devices move with an object contained in the volume of interest;
a means for determining the location and orientation of the imaging devices in the volume of interest;
a means for calibrating the imaging devices;
a means for acquiring data about the object;
a means for correcting the data; and
a means generating a three-dimensional model.

16. The system of claim 14, wherein the imaging devices are manually controlled.

17. The system of claim 14, wherein the imaging devices are remotely controlled.

18. The system of claim 16, wherein the imaging device is mounted on a mobile robotic platform.

19. The system of claim 14, wherein the imaging device further comprises a three degree of freedom orientation sensor and an accelerometer

20. The system of claim 14, wherein the imaging device further comprises a three degree of freedom orientation sensor and a Global Positioning System (GPS) receiver.

21. The system of claim 14, wherein the imaging device further comprises a three degree of freedom orientation sensor, a GPS receiver, and an accelerometer.

22. The system of claim 19, wherein the GPS receiver is operated in differential mode, in conjunction with a GPS base station.

23. A computer readable medium storing a computer program implementing the method of generating a surface model comprising:
utilizing multiple imaging devices;
locating the multiple imaging devices in a volume of interest;
controlling the imaging devices such that the imaging devices move with an object contained in the volume of interest;
determining the location and orientation of the imaging devices in the volume of interest;
calibrating the imaging devices;
acquiring data about the object;
correcting the data; and
generating a three-dimensional model.
